(19) United States
(12) Patent Application Publication
(10) Pub. No.: US 2024/0408804 A1
(43) Pub. Date: Dec. 12, 2024

(54) MOLD CLAMPING DEVICE AND INJECTION MOLDING MACHINE

(71) Applicant: THE JAPAN STEEL WORKS, LTD., Tokyo (JP)

(72) Inventor: Kazuteru MATSUSHITA, Tokyo (JP)

(21) Appl. No.: 18/676,736

(22) Filed: May 29, 2024

(30) Foreign Application Priority Data
Jun. 6, 2023 (JP) 2023-093006

(51) Int. Cl. B29C 45/66

(52) U.S. Cl. CPC B29C 45/661; B29C 2045/662

(57) ABSTRACT

A mold clamping device includes a fixed platen, a movable platen, a mold clamping housing, a plurality of tie bars, and a toggle mechanism provided between the mold clamping housing and the movable platen, in which when link pins connecting the mold clamping housing and two mold clamping housing side links, link pins connecting the movable platen and two movable platen side links, and link pins respectively connecting the two mold clamping housing side links and the two movable platen side links are defined as mold clamping force receiving link pins, at least one of the multiple mold clamping force receiving link pins is defined as a main lubrication target link pin, and the main lubrication target link pin is configured to be greased with a larger amount than each of other mold clamping force receiving link pins.

### CROSS-REFERENCE TO RELATED APPLICATIONS

This application is based on and claims priority under 35 USC 119 from Japanese Patent Application No. 2023-093006 filed on Jun. 6, 2023, the entire content of which is incorporated herein by reference.

### TECHNICAL FIELD

The present disclosure relates to a mold clamping device including a toggle mechanism horizontally laid on a bed, and an injection molding machine.

### BACKGROUND ART

An injection molding machine includes a mold clamping device configured to clamp a mold and an injection device configured to inject an injection material. In a so-called horizontal injection molding machine, a mold clamping device is horizontally laid on a bed, and a mold platen is driven in a horizontal direction to open and close a mold. That is, the mold clamping device includes a fixed platen fixed on the bed, a movable platen slidably provided on the bed, and a mold clamping housing slidably provided on the bed. The fixed platen and the mold clamping housing are connected by a plurality of tie bars, and the movable platen is slidable between the fixed platen and the mold clamping housing. A toggle mechanism including a plurality of links and a crosshead is provided between the mold clamping housing and the movable platen. When the crosshead is driven to open and close the toggle mechanism, the movable platen moves forward and backward in the horizontal direction relative to the mold clamping housing. That is, the mold is opened and closed.

The plurality of links configuring the toggle mechanism are rotatably connected to the mold clamping housing and the movable platen via link pins, and the links are also rotatably connected by link pins. Accordingly, the toggle mechanism slides at the link pins when opening and closing, and friction is generated. A proper amount of grease is thus periodically supplied to the link pins by, for example, a greasing device as described in JP2000-257792A to prevent wear.

### SUMMARY

A plurality of link pins provided in the toggle mechanism are periodically supplied with grease to prevent wear. However, the wear gradually progresses when the injection molding machine is operated over a long period. At this time, it is necessary to replace the link pins. Among the plurality of link pins provided in the toggle mechanism, there may be a link pin that wears out faster than other link pins. When such a link pin becomes worn, it becomes necessary to maintain the toggle mechanism, such as by replacing the link pin, even if the other link pins show little to no wear. In other words, the faster wearing link pin may necessitate more frequent maintenance of the toggle mechanism.

Illustrative aspects of the present disclosure provide a mold clamping device that can reduce wear progression of a link pin that is prone to wear.

Other problems and novel features will become apparent from description of the present description and the accompanying drawings.

According to one illustrative aspect of the present disclosure, in a toggle mechanism, when link pins connecting a mold clamping housing and two mold clamping housing side links, link pins connecting a movable platen and two movable platen side links, and link pins respectively connecting the two mold clamping housing side links and the two movable platen side links are defined as mold clamping force receiving link pins, at least one of the multiple mold clamping force receiving link pins is defined as a main lubrication target link pin. The main lubrication target link pin is configured to be greased with a larger amount than each of other mold clamping force receiving link pins.

According to the present disclosure, it is possible to reduce wear progression of a link pin that is prone to wear.

### BRIEF DESCRIPTION OF DRAWINGS

FIG. 1 is a front view of an injection molding machine according to a first illustrative embodiment;

FIG. 2 is a front view showing a part of a mold clamping device according to the first illustrative embodiment;

FIG. 3A is a perspective view showing a part of the mold clamping device according to the first illustrative embodiment;

FIG. 3B is a front sectional view showing a part of the mold clamping device according to the first illustrative embodiment;

FIG. 4A is a perspective view showing a part of the mold clamping device according to the first illustrative embodiment;

FIG. 4B is a front sectional view showing a part of the mold clamping device according to the first illustrative embodiment;

FIG. 5A is a front sectional view showing a part of the mold clamping device according to the first illustrative embodiment;

FIG. 5B is a front sectional view showing a part of the mold clamping device according to the first illustrative embodiment;

FIG. 6A is a front sectional view showing a part of the mold clamping device according to the first illustrative embodiment;

FIG. 6B is a front sectional view showing a part of the mold clamping device according to the first illustrative embodiment;

FIG. 6C is a front sectional view showing a part of the mold clamping device according to the first illustrative embodiment;

FIG. 7 is a front view showing a part of a mold clamping device according to a second illustrative embodiment;

FIG. 8A is a front sectional view showing a part of the mold clamping device according to the second illustrative embodiment;

FIG. 8B is a front sectional view showing a part of the mold clamping device according to the second illustrative embodiment;

FIG. 9 is a front view showing a part of a mold clamping device according to a third illustrative embodiment; and

FIG. 10 is a front view showing a part of a mold clamping device according to a fourth illustrative embodiment.

### DETAILED DESCRIPTION

Hereinafter, specific illustrative embodiments will be described in detail with reference to the drawings. The present invention is not limited to the following illustrative embodiments. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

### First Illustrative Embodiment

### {Injection Molding Machine}

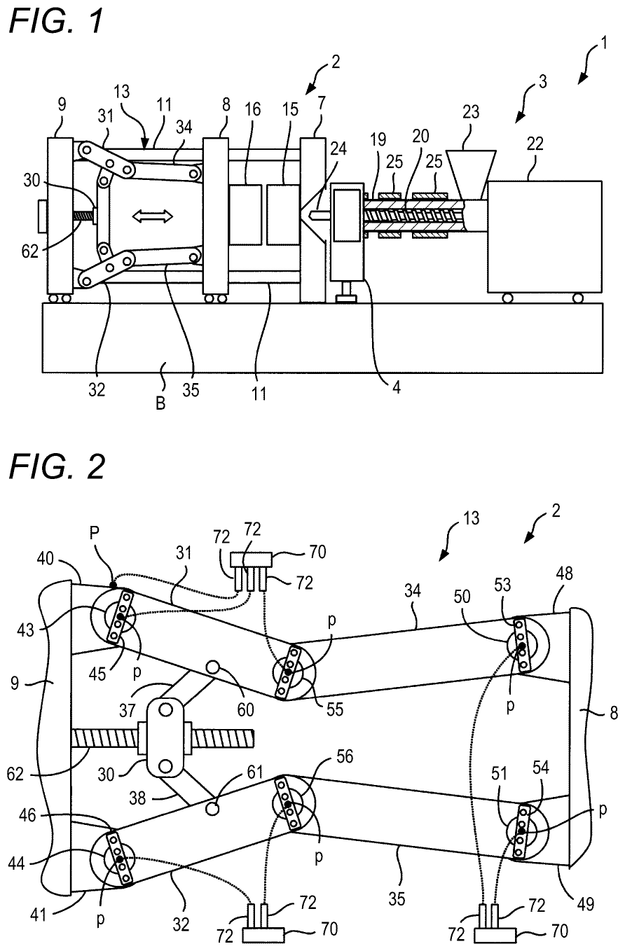

As shown in FIG. 1, an injection molding machine 1 according to a first illustrative embodiment includes a mold clamping device 2 provided on a bed B, an injection device 3 provided on the bed B on a side of the mold clamping device 2, and a control device 4 for controlling the mold clamping device 2 and the injection device 3. The injection molding machine 1 is a so-called horizontally laid machine.

### {Mold Clamping Device}

The mold clamping device 2 includes a fixed platen 7 fixed to the bed B, a movable platen 8 slidably provided on the bed B, and a mold clamping housing 9 slidably provided on the bed B. The fixed platen 7 and the mold clamping housing 9 are coupled by a plurality of tie bars 11, 11, . . . , and the movable platen 8 is disposed between the fixed platen 7 and the mold clamping housing 9. A toggle mechanism 13 is provided between the mold clamping housing 9 and the movable platen 8. The fixed platen 7 and the movable platen 8 are respectively provided with a fixed side mold 15 and a movable side mold 16. Accordingly, when the toggle mechanism 13 is driven, the molds 15 and 16 are opened and closed.

### {Injection Device}

The injection device 3 includes a heating cylinder 19, a screw 20 provided in the heating cylinder 19, and a screw driving device 22. The heating cylinder 19 is supported by the screw driving device 22, and the screw 20 is driven in a rotation direction and an axial direction by the screw driving device 22. The heating cylinder 19 is provided with a hopper 23 and an injection nozzle 24. The heating cylinder 19 is further provided with heaters 25, 25, . . . .

### {Toggle Mechanism}

As shown in FIG. 2, the toggle mechanism 13 includes a crosshead 30 and a plurality of links. The plurality of links include mold clamping housing side links 31 and 32 connected to the mold clamping housing 9, movable platen side links 34 and 35 connected to the movable platen 8, and crosslinks 37 and 38 connecting the crosshead 30 and the mold clamping housing side links 31 and 32. One of the mold clamping housing side links 31 and 32 that is disposed above the crosshead 30 may be referred to as the upper mold clamping housing side link 31, and the other one of the mold clamping housing side links 31 and 32 that is disposed below the crosshead 30 may be referred to as the lower mold clamping housing side link 32. Similarly, one of the movable platen side links 34 and 35 that is disposed on an upper side with reference to the crosshead 30 may also be referred to as the upper movable platen side link 34, and the other one of the movable platen side links 34 and 35 that is disposed on a lower side with reference to the crosshead 30 may also be referred to as the lower movable platen side link 35.

The mold clamping housing 9 is provided with a connecting portion on each of an upper side and a lower side, that is, an upper mold clamping housing clevis 40 and a lower mold clamping housing clevis 41. FIG. 2 shows one upper mold clamping housing clevis 40 and one lower mold clamping housing clevis 41, and another upper mold clamping housing clevis 40 and another lower mold clamping housing clevis 41 are respectively provided in a depth direction of a paper surface. That is, two upper mold clamping housing clevises 40 and two lower mold clamping housing clevises 41 are provided in the mold clamping housing 9, and one upper mold clamping housing clevis 40 and one lower mold clamping housing clevis 41 are hidden due to being displayed in an overlapped manner in FIG. 2. The upper mold clamping housing side link 31 and the lower mold clamping housing side link 32 are rotatably connected to the upper mold clamping housing clevis 40 and the lower mold clamping housing clevis 41 by horizontal link pins 43 and 44, respectively. That is, two link pins 43 and two link pins 44 are provided although only one link pin 43 and one link pin 44 are shown in FIG. 2.

The link pins 43 and 44 are fixed to the upper mold clamping housing side link 31 and the lower mold clamping housing side link 32 by fixing members 45 and 46, respectively. Accordingly, when the toggle mechanism 13 opens and closes, the link pins 43 and 44 rotate integrally with the upper mold clamping housing side link 31 and the lower mold clamping housing side link 32, and slide against the upper mold clamping housing clevis 40 and the lower mold clamping housing clevis 41.

Similarly, the movable platen 8 is provided with an upper movable platen clevis 48 and a lower movable platen clevis 49, to which the upper movable platen side link 34 and the lower movable platen side link 35 are rotatably connected by horizontal link pins 50 and 51, respectively. The link pins 50 and 51 are fixed to the upper movable platen side link 34 and the lower movable platen side link 35 by fixing members 53 and 54, respectively. Two upper movable platen clevises 48 and two lower movable platen clevises 49 are provided, two link pins 50 and two link pins 51 are provided. However, in FIG. 2, one of each—the upper movable platen clevis 48, the lower movable platen clevis 49, the link pin 50, and the link pin 51—is hidden. The upper mold clamping housing side link 31 and the upper movable platen side link 34 are rotatably connected by a horizontal link pin 55, and the lower mold clamping housing side link 32 and the lower movable platen side link 35 are rotatably connected by a horizontal link pin 56.

The link pins 43, 44, 50, 51, 55, and 56 directly receive a mold clamping force during mold clamping, and are thus referred to as mold clamping force receiving link pins 43, 44, 50, and 51 in the present specification. In the first illustrative embodiment, a part of the mold clamping force receiving link pins 43, 44, 50, 51, 55, and 56 is a main lubrication target link pin to be mainly greased as will described later.

The crosslinks 37 and 38 are connected to the upper mold clamping housing side link 31 and the lower mold clamping housing side link 32 via link pins 60 and 61, respectively. These crosslinks 37 and 38 are connected to the crosshead 30. The link pins 60 and 61 do not directly receive the mold clamping force, and are thus excluded from the mold clamping force receiving link pins in the present specification. The crosshead 30 is driven by a ball screw mechanism 62.

### {Greasing Mechanism for Toggle Mechanism}

A greasing mechanism for greasing the toggle mechanism 13 according to the first illustrative embodiment will be described. The greasing mechanism includes a grease pump not shown in FIG. 2, junctions 70, 70, . . . connected to the grease pump, and a plurality of grease metering valves 72, 72, . . . provided in the junctions 70, 70, . . . . The junctions 70, 70, . . . are fixed to the mold clamping housing 9, the movable platen 8, and the like. However, for clarity in FIG. 2, the junctions 70, 70, . . . are shown apart from the mold clamping housing 9, the movable platen 8, and the like.

The grease metering valves 72, 72, . . . shown in FIG. 2 are connected to the mold clamping force receiving link pins 43, 44, 50, 51, 55, and 56 to supply grease. That is, the link pins 43, 44, . . . 55, and 56 have greasing points p, p, . . . in centers thereof, to which the grease metering valves 72, 72, . . . are respectively connected. The link pins 43, 44, . . . have the same or similar size. That is, the link pins 43, 44, . . . require equal amounts of grease. Accordingly, as shown in FIG. 2, the grease metering valves 72, 72, . . . are all of the same type. When the grease pump is driven, the same prescribed amount of grease is supplied to each of the grease metering valves 72, 72, . . . to grease the greasing points p, p, . . . .

The other link pins 60, 61, . . . provided in the toggle mechanism 13 also have greasing points, but are not shown in FIG. 2. The link pins 60, 61, . . . have smaller sizes than the mold clamping force receiving link pins 43, 44, . . . 55 and 56, and thus require smaller amounts of grease. The link pins 60, 61, . . . may adopt grease metering valves of the same type as the grease metering valves 72, 72, . . . , and adopt a different type so that greasing amounts are reduced.

The mold clamping force receiving link pins 43, 44, . . . 55 and 56 are each greased by the same amount. In the first illustrative embodiment, however, the upper mold clamping housing clevis 40 also has a greasing point P, to which the grease metering valve 72 is connected. The greasing point P is connected to the mold clamping force receiving link pin 43 connecting the upper mold clamping housing clevis 40 and the upper mold clamping housing side link 31.

That is, the mold clamping force receiving link pin 43 is a main lubrication target link pin having a larger greasing amount than the other mold clamping force receiving link pins 44, 50 and 51.

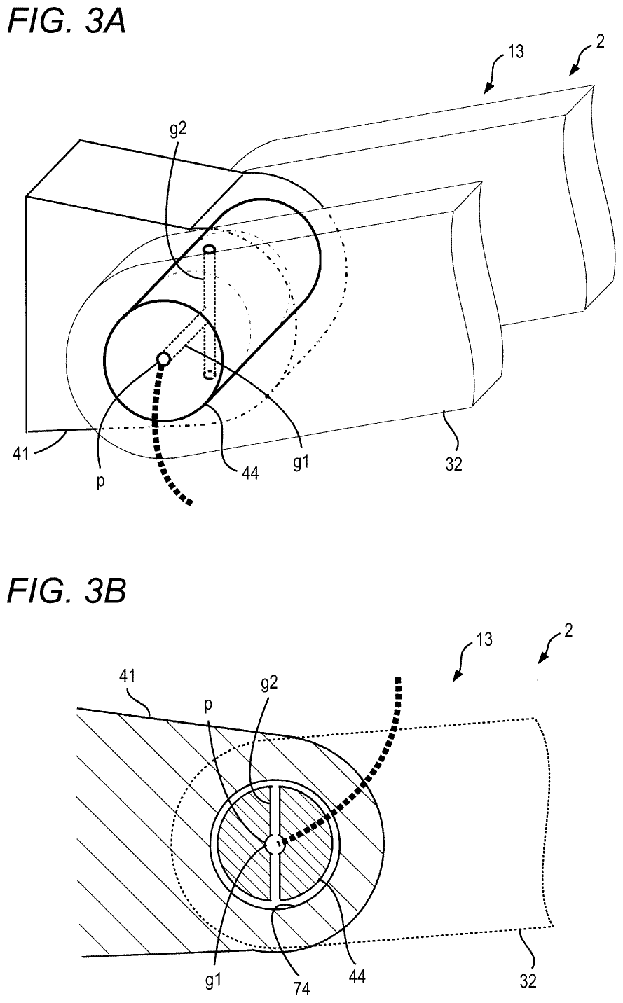

FIGS. 3A and 3B show the mold clamping force receiving link pin 44 connecting the lower mold clamping housing clevis 41 and the lower mold clamping housing side link 32. Next, a mechanism of greasing will be described with reference to the mold clamping force receiving link pin 44 as a representative of the other mold clamping force receiving link pins 44, 50, . . . and 56 that are not main lubrication target link pins. The mold clamping force receiving link pin 44 has the greasing point p at an end surface and a grease passage g1 in a central axis of the mold clamping force receiving link pin 44. The mold clamping force receiving link pin 44 further has a grease passage g2 running in a radial direction in a substantially center thereof, which communicates with the grease passage g1. When the mold clamping force receiving link pin 44 is greased from the greasing point p, grease is supplied to an outer peripheral surface of the mold clamping force receiving link pin 44 through the grease passages g1 and g2. At this time, a lower half and an upper half of the mold clamping force receiving link pin 44 are each greased by the same amount. Lubrication is ensured between the mold clamping force receiving link pin 44 and a pin hole 74 of the lower mold clamping housing clevis 41.

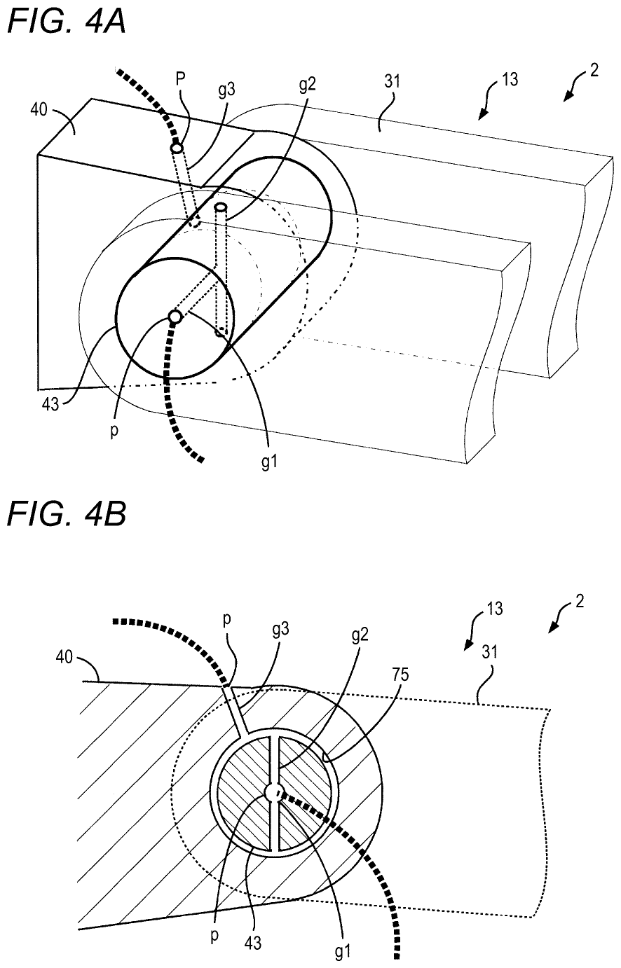

A mechanism of greasing for the mold clamping force receiving link pin 43, which is a main lubrication target link pin, will be described with reference to FIGS. 4A and 4B. The mold clamping force receiving link pin 43 provided on the upper mold clamping housing side link 31 also has the greasing point p on an end surface, the grease passage g1 in a central axis, and the grease passage g2 in a radial direction to be greased. In addition, as described above, the upper mold clamping housing clevis 40 has the greasing point P. The upper mold clamping housing clevis 40 further has a grease passage g3 that reaches a pin hole 75 thereof from the greasing point P. That is, the mold clamping force receiving link pin 43, which is a main lubrication target link pin, is greased substantially twice an amount of each of the other mold clamping force receiving link pins 44, 50, . . . and 56.

Further, the grease passage g3 opens to an upper side of a circumferential surface of the mold clamping force receiving link pin 43. That is, the mold clamping force receiving link pin 43 is greased from above the circumferential surface thereof. Therefore, when the grease is supplied from the greasing points p and P, a larger amount of the grease is applied to an upper side than a lower side of the circumferential surface of the mold clamping force receiving link pin 43.

### {Mold Clamping Force Receiving Link Pins of Lower Mold Clamping Housing Side Links}

The mold clamping force receiving link pin 43, which is a main lubrication target link pin, differs from the other mold clamping force receiving link pins 44, 50 and 51 in a lubrication state after operation over a long period. In order to eliminate the difference in the lubrication state, the main lubrication target link pin is greased with a larger amount than the other mold clamping force receiving link pins 44, 50, . . . and 56. Alternatively, a larger greasing amount is necessary for the upper half than the lower half of the circumferential surface of the link pin. To understand this, lubrication states of the other mold clamping force receiving link pins 44, 50, . . . and 56 will be described first.

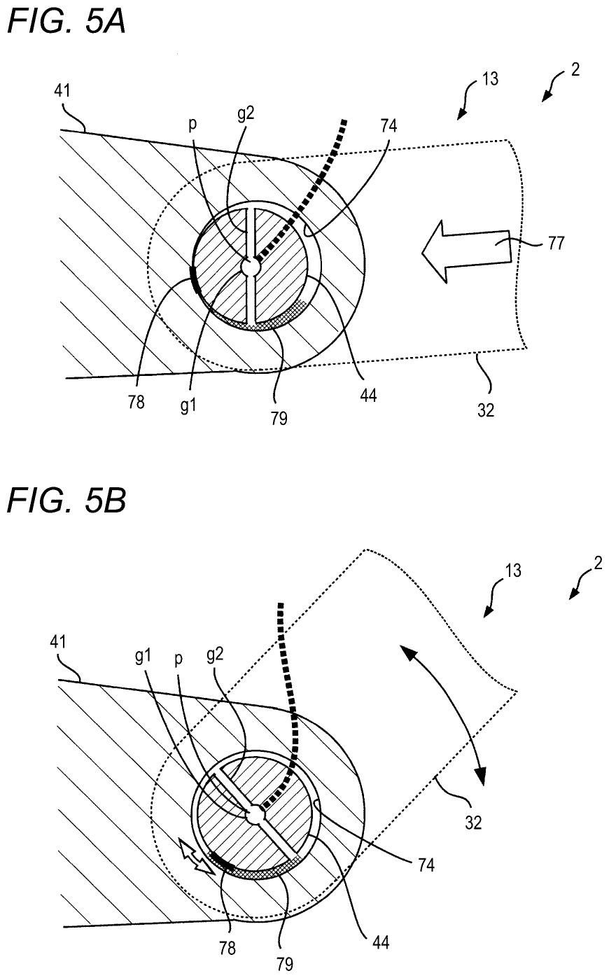

FIG. 5A shows the mold clamping force receiving link pin 44, which couples the lower mold clamping housing clevis 41 and the lower mold clamping housing side link 32, as a representative of the other mold clamping force receiving link pins 44, 50, . . . and 56. FIG. 5A shows a state in which the toggle mechanism 13 is expanded (in other words, opened) for mold clamping. During mold clamping, a force acts on the lower mold clamping housing side link 32 in a direction of an arrow 77, and thus the mold clamping force receiving link pin 44 is largely pressed against the pin hole 74 at a contact part 78. That is, the contact part 78 is prone to wear when no grease adheres. Although grease 79 enters the pin hole 74, the grease 79 may not reach the contact part 78 in a mold clamped state when the grease 79 is of a small amount.

However, when the toggle mechanism 13 contracts as shown in FIG. 5B, the contact part 78 rotates downward. At this time, the grease 79 accumulates in a vicinity of a bottom of the pin hole 74 even when the grease 79 is of a small amount, and thus the grease necessary for the contact part 78 adheres. In this case, even when the toggle mechanism 13 is opened next time as shown in FIG. 5A, the contact part 78 is less prone to wear since sufficient grease adheres. When grease is supplied from the greasing point p, sufficient lubrication can be ensured even by a relatively small amount.

### {Main Lubrication Target Link Pin}

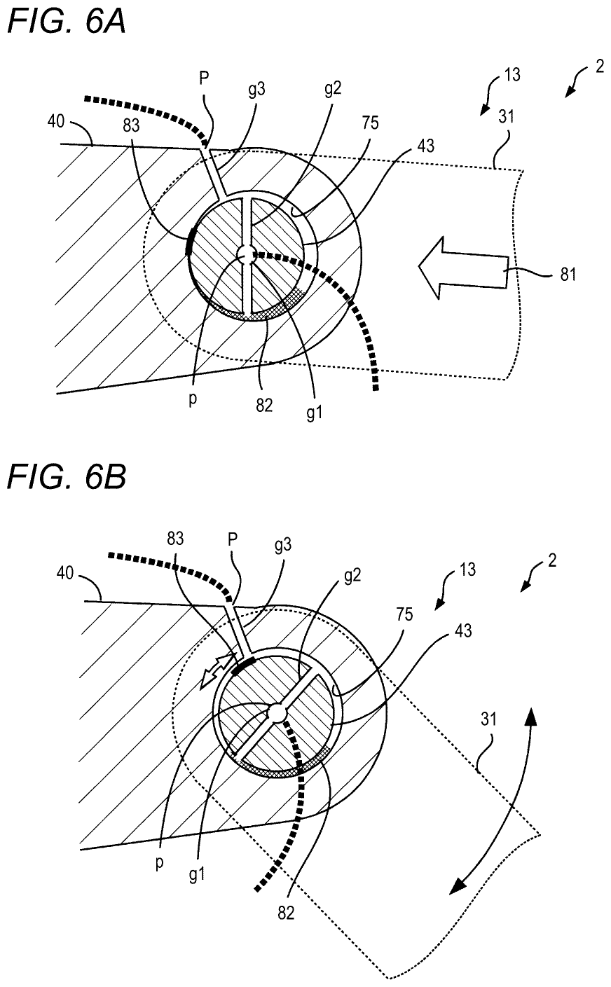

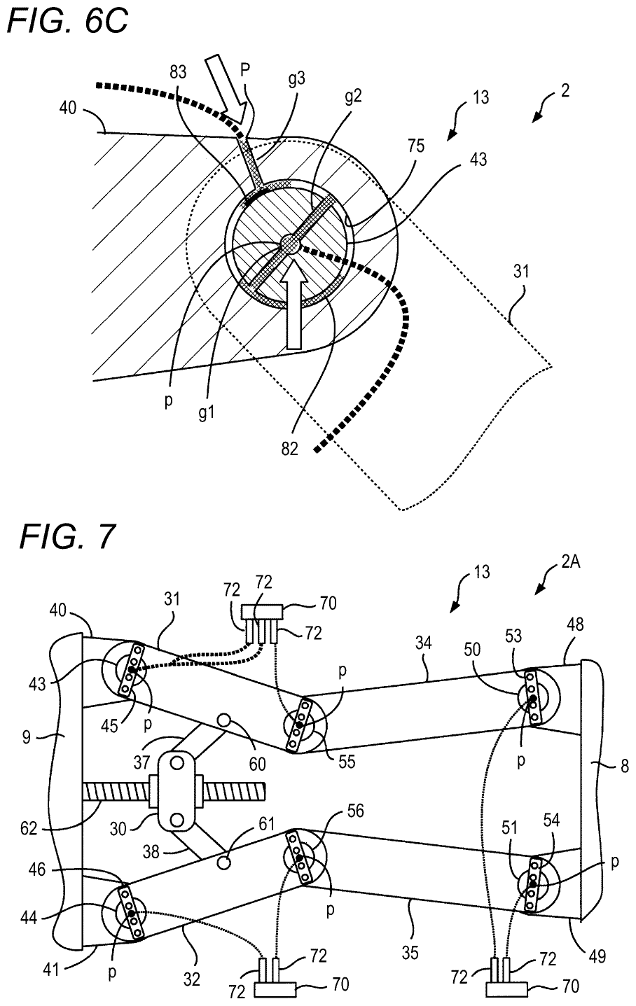

The lubrication state of the mold clamping force receiving link pin 43, which is a main lubrication target link pin, is considered. FIG. 6A shows a state in which the toggle mechanism 13 is expanded (in other words, opened) for mold clamping. During mold clamping, a force acts on the upper mold clamping housing side link 31 in a direction of an arrow 81, and thus the mold clamping force receiving link pin 43 is largely pressed against the pin hole 75 at a contact part 83. That is, the contact part 83 is prone to wear when no grease adheres. When grease 82 entering the pin hole 75 is of a small amount, the grease 82 may not reach the contact part 83 in the mold clamped state.

As shown in FIG. 6B, when the toggle mechanism 13 contracts, the contact part 83 rotates upward. At this time, the contact part 83 further moves in a direction in which the grease becomes less. When no grease adheres to the contact part 83, the mold clamping force receiving link pin 43 is largely pressed against the pin hole 75 in a state in which the contact part 83 is not sufficiently lubricated when the mold is clamped next time. At this time, greasing is necessary since the contact part 83 is prone to wear.

When greasing the mold clamping force receiving link pin 43 which is a main lubrication target link pin, as shown in FIG. 6C, the grease is applied not only at the greasing point p but also at the greasing point P. In doing so, the mold clamping force receiving link pin 43 receives substantially twice an amount of grease compared to each of the other mold clamping force receiving link pins 44, 50, . . . and 56 (see FIG. 2). At this time, the grease sufficiently adheres to the contact part 83. Further, since a larger amount of grease is applied to an upper half than a lower half of a circumferential surface of the mold clamping force receiving link pin 43, the grease is more likely to adhere to the contact part 83, which is located on the upper side. Accordingly, a sufficient lubrication state is ensured at the contact part 83, and thus wear is reduced.

FIGS. 6A and 6B show that the grease 82 accumulates in a lower portion of the pin hole 75. However, since the grease is actually viscous, the grease adheres to an upper portion of the pin hole 75 to a certain degree. Accordingly, when the toggle mechanism 13 opens and closes, the contact part 83 would not be completely dried even when the grease 82 is of a small amount. However, the amount of grease adhering to the contact part 83 is prone to be small since the contact part 83 is normally located on the upper side during the opening and closing of the toggle mechanism 13. In the first illustrative embodiment, a larger amount of grease is applied to the upper half than the lower half of the circumferential surface of the mold clamping force receiving link pin 43, which is a main lubrication target link pin. As a result, even when the amount of grease supplied is not double, the grease is more likely to adhere to the contact part 83, ensuring lubrication.

### Second Illustrative Embodiment

### {Injection Molding Machine According to Second Illustrative Embodiment}

An injection molding machine according to a second illustrative embodiment includes the injection device 3 and the control device 4 the same as those in the injection molding machine 1 according to the first illustrative embodiment shown in FIG. 1. A mold clamping device 2A is the same as that in the injection molding machine 1 according to the first illustrative embodiment except for a greasing mechanism for the toggle mechanism 13. Accordingly, description of the mold clamping device 2A and the injection device 3 will be omitted.

### {Greasing Mechanism for Toggle Mechanism}

FIG. 7 shows the toggle mechanism 13 and the greasing mechanism therefor in the mold clamping device 2A according to the second illustrative embodiment. The second illustrative embodiment is different from the first illustrative embodiment in two points. The first difference is that the upper mold clamping housing clevis 40 has no greasing point P (see FIG. 2) in the second illustrative embodiment. The second difference is that two grease metering valves 72, 72 are connected to the greasing point p of the mold clamping force receiving link pin 43. That is, the mold clamping force receiving link pin 43 is a main lubrication target link pin, and receives twice an amount of grease compared to each of the other mold clamping force receiving link pins 44, 50, . . . and 56.

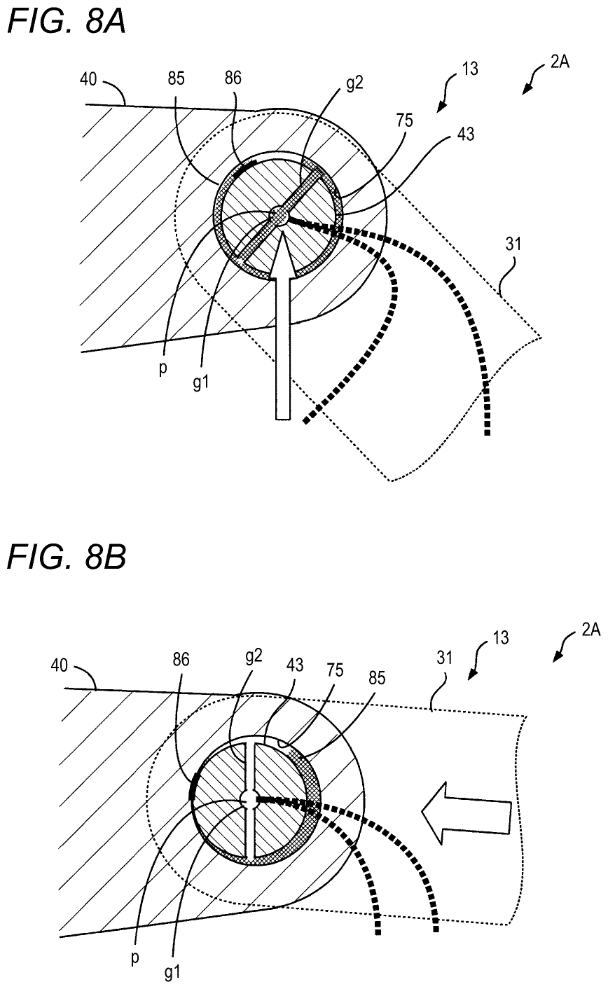

FIG. 8A shows a state in the mold clamping device 2A according to the second illustrative embodiment where the mold clamping force receiving link pin 43, which is a main lubrication target link pin, is greased from the greasing point p. Since substantially double the amount of grease is applied to the mold clamping force receiving link pin 43 from the greasing point p, a sufficient amount of grease 85 is supplied to the pin hole 75. Accordingly, sufficient grease adheres to a contact part 86. Even when the toggle mechanism 13 is opened for mold clamping as shown in FIG. 8B, a sufficient amount of grease adheres to the contact part 86. Accordingly, wear is reduced even when the mold clamping force receiving link pin 43 is largely pressed against the pin hole 75.

### Third Illustrative Embodiment

### {Injection Molding Machine According to Third Illustrative Embodiment}

An injection molding machine according to a third illustrative embodiment includes the injection device 3 and the control device 4 the same as those in the injection molding machine 1 according to the first illustrative embodiment shown in FIG. 1. A mold clamping device 2B is configured in the same way as the injection molding machine 1 according to the first illustrative embodiment, except for a greasing mechanism for the toggle mechanism 13. Accordingly, description of the mold clamping device 2B and the injection device 3 will be omitted.

### {Greasing Mechanism for Toggle Mechanism}

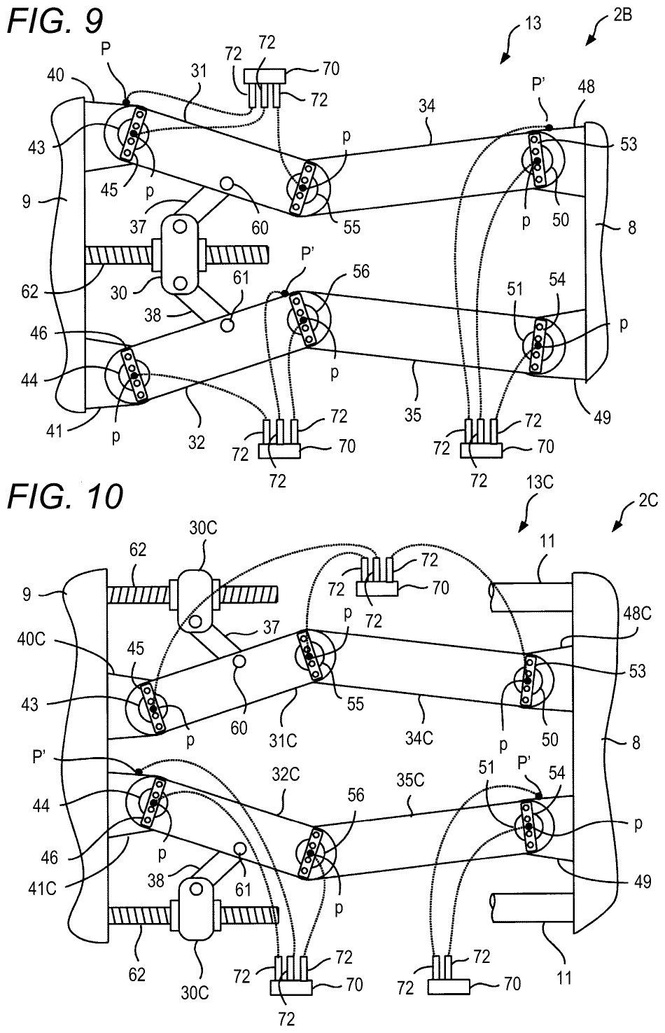

FIG. 9 shows the toggle mechanism 13 and the greasing mechanism therefor in the mold clamping device 2B according to the third illustrative embodiment. The third illustrative embodiment is different from the first illustrative embodiment in two points. That is, in the third illustrative embodiment, not only the mold clamping force receiving link pin 43 but also the mold clamping force receiving link pins 50 and 56 are main lubrication target link pins. That is, the mold clamping force receiving link pin 50 has a greasing point P′ at the upper movable platen clevis 48, and is greased from the grease metering valve 72. Similarly, the mold clamping force receiving link pin 56 has the greasing point P′ at the lower mold clamping housing side link 32. Accordingly, the mold clamping force receiving link pins 50 and 56 receive twice the amount of grease compared to each of the other mold clamping force receiving link pins 44, 51 and 55. Then, a larger amount of grease is applied to an upper half than a lower half of a circumferential surface of the mold clamping force receiving link pins 50 and 56.

### Fourth Illustrative Embodiment

### {Injection Molding Machine According to Fourth Illustrative Embodiment}

An injection molding machine according to a fourth illustrative embodiment is configured with the injection device 3 and the control device 4 in the same way as the injection molding machine 1 according to the first illustrative embodiment shown in FIG. 1. Accordingly, description of the injection device 3 and the control device will be omitted. As shown in FIG. 10, a toggle mechanism 13C of a mold clamping device 2C is different from that in the first illustrative embodiment. Members having the same functions as those in the first illustrative embodiment are denoted by the same reference numerals and description thereof is omitted. Differences will be described.

### {Toggle Mechanism}

The mold clamping device 2C according to the fourth illustrative embodiment includes two crossheads 30C, and the toggle mechanism 13C is separated into upper and lower two parts. First, the upper toggle mechanism 13C is as follows. That is, the upper toggle mechanism 13C includes an upper mold clamping housing side link 31C connected to an upper mold clamping housing clevis 40C, an upper movable platen side link 34C connected to an upper movable platen clevis 48C, the crosslink 37, and the crosshead 30C. The lower toggle mechanism 13C includes a lower mold clamping housing side link 32C connected to a lower mold clamping housing clevis 41C, a lower movable side link 35C connected to a lower movable platen clevis 49C, the crosslink 38, and the crosshead 30C.

In the toggle mechanism 13C of the mold clamping device 2C according to the fourth illustrative embodiment, the lower mold clamping housing side link 32C and the lower movable side link 35C are disposed above the crosshead 30C to which they are connected. In this configuration, when an amount of grease is low, the link pins 44 and 51 are relatively prone to grease shortage. Therefore, in the fourth illustrative embodiment, among the mold clamping force receiving link pins 44, 45, . . . and 56, the link pins 44 and 51 are identified as main lubrication target link pins having the greasing points P′, P′, and receive twice the amount of grease compared to the other link pins.

Although the invention made by the present inventor is specifically described based on the illustrative embodiments, it is needless to say that the present invention is not limited to the illustrative embodiments described above, and various modifications can be made without departing from the scope of the present invention. The above-described plurality of examples may be appropriately combined.

What is claimed is:

1. A mold clamping device comprising:
a fixed platen fixed on a bed;
a movable platen slidably provided on the bed;
a mold clamping housing slidably provided on the bed;
a plurality of tie bars coupling the fixed platen and the mold clamping housing; and
a toggle mechanism provided between the mold clamping housing and the movable platen,
wherein the toggle mechanism includes:
two mold clamping housing side links, each rotatably connected to the mold clamping housing via respective horizontal link pins;
two movable platen side links, each rotatably connected to the movable platen via respective horizontal link pins;
a crosshead; and
two crosslinks,
wherein the two mold clamping housing side links and the two movable platen side links are rotatably connected via respective horizontal link pins, and the two mold clamping housing side links are each connected to the crosshead via respective two crosslinks,
wherein when the link pins connecting the mold clamping housing and the two mold clamping housing side links, the link pins connecting the movable platen and the two movable platen side links, and the link pins respectively connecting the two mold clamping housing side links and the two movable platen side links are defined as mold clamping force receiving link pins, at least one of the multiple mold clamping force receiving link pins is defined as a main lubrication target link pin, and
wherein the main lubrication target link pin is configured to be greased with a larger amount than each of other mold clamping force receiving link pins.

2. The mold clamping device according to claim 1, wherein the main lubrication target link pin is configured to be greased with a larger amount at an upper half than at a lower half of a circumferential surface of the link pin.

3. The mold clamping device according to claim 1, wherein the main lubrication target link pin is the mold clamping force receiving link pin connecting the mold clamping housing side link disposed above the crosshead and the mold clamping housing.

4. The mold clamping device according to claim 1, wherein the main lubrication target link pin is the mold clamping force receiving link pin connecting the movable platen side link disposed above the crosshead and the movable platen.

5. The mold clamping device according to claim 1,
wherein the main lubrication target link pin has one or multiple greasing points, and
wherein the number of the greasing point is greater at least at an upper half than at a lower half of a circumferential surface of the link pin.

6. The mold clamping device according to claim 1,
wherein the main lubrication target link pin has one or multiple greasing points, and
wherein the main lubrication target link pin is configured to receive a larger total amount of grease at least at an upper half than at a lower half of a circumferential surface of the main lubrication target link pin.

7. An injection molding machine comprising:
a mold clamping device configured to clamp a mold; and
an injection device configured to inject an injection material,
wherein the mold clamping device includes:
a fixed platen fixed on a bed;
a movable platen slidably provided on the bed;
a mold clamping housing slidably provided on the bed;
a plurality of tie bars coupling the fixed platen and the mold clamping housing; and
a toggle mechanism provided between the mold clamping housing and the movable platen,
wherein the toggle mechanism includes:
two mold clamping housing side links, each rotatably connected to the mold clamping housing via respective horizontal link pins;
two movable platen side links, each rotatably connected to the movable platen via respective horizontal link pins;
a crosshead; and
two crosslinks,
wherein the two mold clamping housing side links and the two movable platen side links are rotatably connected via respective horizontal link pins, and the two mold clamping housing side links are each connected to the crosshead via respective two crosslinks,
wherein when the link pins connecting the mold clamping housing and the two mold clamping housing side links, the link pins connecting the movable platen and the two movable platen side links, and the link pins respectively connecting the two mold clamping housing side links and the two movable platen side links are defined as mold clamping force receiving link pins, at least one of the multiple mold clamping force receiving link pins is defined as a main lubrication target link pin, and
wherein the main lubrication target link pin is configured to be greased with a larger amount than each of other mold clamping force receiving link pins.

8. The injection molding machine according to claim 7, wherein the main lubrication target link pin is configured to be greased with a larger amount at an upper half than at a lower half of a circumferential surface of the link pin.

9. The injection molding machine according to claim 7, wherein the main lubrication target link pin is the mold clamping force receiving link pin connecting the mold clamping housing side link disposed above the crosshead and the mold clamping housing.

10. The injection molding machine according to claim 7, wherein the main lubrication target link pin is the mold clamping force receiving link pin connecting the movable platen side link disposed above the crosshead and the movable platen.

11. The injection molding machine according to claim 7,
wherein the main lubrication target link pin has one or multiple greasing points, and
wherein the number of the greasing point is greater at least at an upper half than at a lower half of a circumferential surface of the link pin.

12. The injection molding machine according to claim 7,
wherein the main lubrication target link pin has one or multiple greasing points, and
wherein a total amount of grease supplied is larger at least at an upper half than at a lower half of a circumferential surface of the link pin.

13. The injection molding machine according to claim 7, wherein the mold clamping force receiving link pin has a first greasing point at an end surface thereof, the mold clamping force receiving link pin having:
a first grease passage in an axis direction thereof; and
a second grease passage running in a radial direction thereof and communicating with the first grease passage, allowing for the same amount of grease to be applied both a lower half and an upper half of the mold clamping force receiving link pin.

14. The injection molding machine according to claim 13,
wherein the mold clamping housing is provided with an upper mold clamping housing clevis and a lower mold clamping housing clevis,
wherein the upper mold clamping housing clevis has:
a pin hole for housing the mold clamping force receiving link pin;
a second greasing point;
a third grease passage that reaches the pin hole from the third greasing point, and
wherein the third grease passage opens to an upper side of a circumferential surface of the mold clamping force receiving link pin, allowing the mold clamping force receiving link pin to be greased from above the circumferential surface thereof.

15. The injection molding machine according to claim 13, wherein two grease metering valves are connected to the first greasing point.

16. The injection molding machine according to claim 13,
wherein the movable platen is provided with an upper movable platen clevis and a lower movable platen clevis, and
wherein the upper movable platen clevis has a second greasing point, allowing for additional greasing of the mold clamping force receiving link pin accommodated in the upper movable platen clevis from the second greasing point.
